(19) United States
(12) Patent Application Publication
(10) Pub. No.: US 2004/0117304 A1
(43) Pub. Date: Jun. 17, 2004

(54) Method for billing services using a prepaid account

(76) Inventors: Georg Kastelewicz, Berlin (DE); Peter Kim, Berlin (DE)

Correspondence Address: MORRISON & FOERSTER LLP, 1650 TYSONS BOULEVARD, SUITE 300, MCLEAN, VA, 22102, US

(21) Appl. No.: 10/473,602

(22) PCT Filed: Mar. 28, 2002
(86) PCT No.: PCT/DE02/01249

(30) Foreign Application Priority Data
Apr. 2, 2001 (DE) 101173091
Apr. 4, 2001 (DE) 101178433

(51) Int. Cl. G06F 17/60

(52) U.S. Cl. 705/40; 705/39

(57) ABSTRACT

The invention relates to a method for billing chargeable services using a prepaid account managed in a communication network for a communication terminal that is registered in said network. To bill the chargeable services, at least one billing message is transmitted by a payment request device to an account management device of the prepaid account via a signalling system of the communication network that controls the establishment of a communication link. The payment request device (ZAE) provides the billing message (VN) with an address for the communication terminal (KEG) and said message is routed to a device exchange (CSCF1) that is assigned to the communication terminal (KEG). The exchange determines an identification address for the account management device (KFE) based on the address of the communication terminal (KEG) and the billing message (VN) is routed to the account management device (KFE).

The invention relates to a method for billing for chargeable services using a credit account which is managed in a communication network for a communication terminal registered in the communication network.

It is general knowledge that, in communication networks, charges for communication services are debited from credit accounts (“prepaid accounts”) managed in these communication networks. In this context, these credit accounts are associated with communication terminals (e.g. landline telephones, mobile phones) registered in the communication network. From such a communication terminal, it is possible to set up and conduct communication links for as long as the associated credit account contains a charge credit. Once the charge credit has been used up, it is no longer possible to set up new communication links and existing communication links are interrupted.

German laid-open specification DE 199 05 054 A1 has disclosed a method in which messages which relate to payment transactions taking place using prepaid credits are transmitted from a communication terminal associated with a payee to a communication terminal associated with a payer, which communication terminal then notifies the service control point in an intelligent network.

German patent specification DE 44 12 727 C2 has disclosed a method for billing charges in a mobile radio system, in which precharging is carried out using an intelligent network, with a debit center connected to a mobile radio switching center being in the form of part of a service control point in the intelligent network.

Furthermore, DE 36 89 214 T2 has disclosed a method for refusing to forward a connection via a message transmission network, in which messages relating to telephone charges are transmitted between the database and trunk exchanges using a central channel signaling system.

The invention is based on the object of specifying a method which can be used for securely and reliably billing for chargeable services using credit accounts in communication networks.

The invention achieves this object by means of a method of the type indicated initially, in which at least one charging message is transmitted from a payment request device to an account management device for the credit account via a signaling system in a communication network, which signaling system controls communication link setup, by virtue of the charging message being provided with an address for the communication terminal by the payment request device, the address of the communication terminal being taken as a basis for routing the charging message from switching centers associated with the message routing mechanism to an appliance switching center associated with the communication terminal, the appliance switching center taking the address of the communication terminal as a basis for ascertaining a characteristic address for the account management device, and the charging message being routed to the account management device determined by this characteristic address.

A particular advantage in this context is that the charging message is transmitted using a signaling system in the communication network which controls communication link setup. Such a signaling system is contained in modern communication networks for the purpose of setting up, conducting and clearing down communication links (session setup, mid-session signaling, cleardown of the session). The use of a basically already existing signaling system allows the charging messages to be transmitted with little involvement. In addition, it is particularly advantageous that the payment request device needs to have just the address of the communication terminal (with which the credit account is associated) in order to transmit the charging message to the credit account's account management device.

The inventive method can be in a form such that the charging message is routed to the account management device by a packet-oriented message routing mechanism in the signaling system.

The inventive method can also be in a form such that the charging message is protected against access by unauthorized parties by a message protection mechanism in the signaling system.

In the embodiments of the inventive method which are cited above, a particular advantage is that the charging messages can be routed to their destination and protected against access by unauthorized parties with little involvement.

This is advantageous particularly because it is necessary to take into account the security requirements of the method users when billing for services. In particular, it is necessary to protect all data which are transmitted during the method (e.g. data relating to the credit account, to the payment sums or personal data for the method users) against misuse. The security aspect becomes particularly important when parts of communication networks are formed by “nonsecure networks”. In this context, such a “nonsecure network” is intended to be understood to mean such a network in which data transported by the network can be monitored, copied or changed by unauthorized parties without the sender of the data or a receiver of the data noticing or being able to prevent this.

An example of such a “nonsecure network” is the Internet (use of the IP protocol), in which data packets (“IP packets”) can be monitored, copied or changed. If such a “nonsecure network” is used even just in subregions of a communication network, then the security of the data transmitted in this communication network is at risk.

The inventive method can be in form a such that

the charging message is used to transmit an identifier for the communication terminal and a payment sum, and

the account management device debits a debit sum, which is dependent on the payment sum, from the credit account when the charging message has arrived.

The inventive method can be in a form such that debiting of the debit sum is followed by transmission of an acknowledgement message to the payment request device.

In this context, it is particularly advantageous that the payment request device is informed about successful debiting of the debit sum in real time.

The inventive method can also be in a form such that the communication network used is a communication network which has telecommunication links which are not protected against access by unauthorized parties. A particular advantage of such an embodiment is that, despite the existence of unprotected telecommunication links, the charging messages can be transmitted securely by the signaling system which controls communication link setup.

The inventive method can also be in a form such that the payment request device used is a payment request device which is outside the control of an operator of the communication network. Such payment request devices also advantageously allow billing for chargeable services using the communication network's credit account.

The inventive method can also be in a form such that the payment request device used is a payment request device which is associated with a request communication network which is connected to the communication network by the signaling system. This embodiment advantageously allows billing for chargeable services using the communication network's credit account even when the payment request device is arranged in a communication network other than the communication network which contains the credit account.

The inventive method can also be in a form such that a signaling system is used in which a message transmission protocol called the “Session Initiation Protocol” is used.

To explain the invention further,

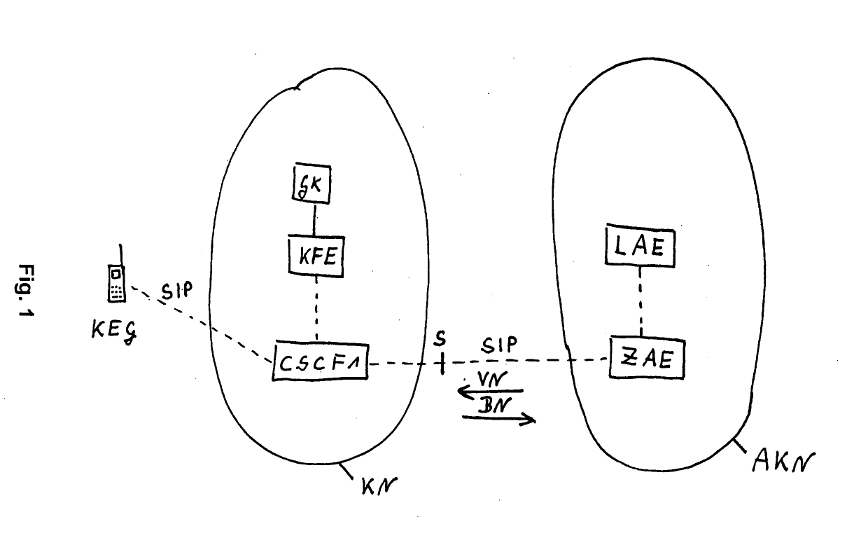

FIG. 1 shows an exemplary embodiment of a communication network and of a request communication network for using the billing method, and

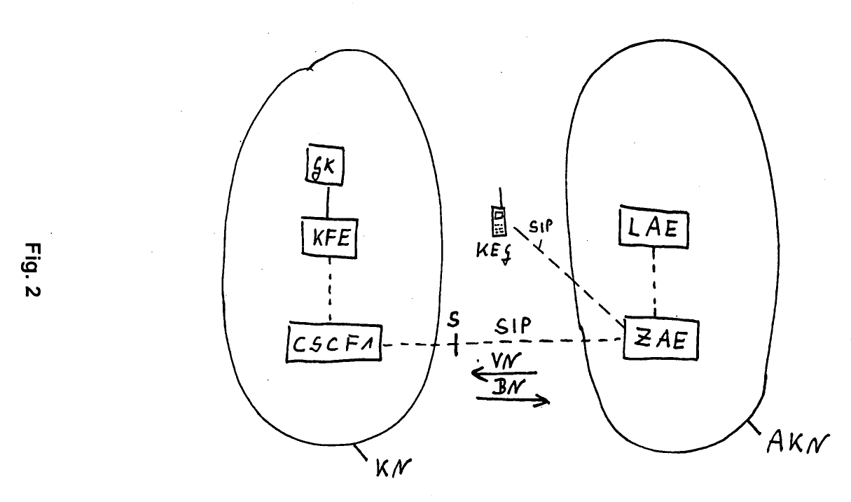

FIG. 2 shows another exemplary embodiment of a communication network and of a request communication network for using the billing method.

FIG. 1 shows a communication network KN which can be connected to a communication terminal KEG. The communication terminal KEG is registered in the communication network KN, and the communication network KN is thus the home network of the communication terminal KEG. The user of the communication terminal KEG is accordingly also referred to as a home user. For the communication network KN, just the components which are fundamental to the invention are shown schematically. The communication network KN contains an appliance switching center CSCF1 associated with the communication terminal KEG, an account management device KFE and a credit account GK managed by the account management device KFE. The credit account GK is associated with the communication terminal KEG. The communication terminal KEG is connected to the appliance switching center CSCF1 via a signaling system SIP which controls communication link setup. This signaling system is shown schematically as a dashed line. This signaling system also connects the appliance switching center CSCF1 to the account management device KFE. On the right-hand side of the communication network KN, the figure shows a request communication network AKN which contains a payment request device ZAE. The payment request device ZAE is connected to a service provider device LAE which provides a chargeable service for the communication terminal KEG. The payment request device ZAE in the request communication network AKN is connected to the appliance switching center CSCF1 in the communication network KN, likewise via the signaling system SIP which controls communication link setup. This signaling system is used not just for controlling communication link setup but also for controlling the entire procedure of the communication link and also for controlling cleardown of this communication link.

In this exemplary embodiment, the communication network KN is intended to be based on the UMTS standard (UMTS=Universal Mobile Telecommunication System).

For use in such a UMTS communication network, for example, a signaling system is known which operates using a protocol called the “Session Initiation Protocol” (SIP) and is referred to below as the signaling system SIP for short. Such a signaling system is described, by way of example, in the printed document 3G TS 23.228 V1.7.0 dated February 2001 entitled: “Third Generation Partnership Project; Technical Specification Group services and System Aspects; IP Multimedia (IM) Subsystem—Stage 2”, particularly in section 4.4 “Signaling Concepts”.

An exemplary embodiment of the method for billing for services now proceeds as follows.

A user of the communication terminal KEG (service user) wishes to make use of a service (that is to say to use a service) which is offered and/or provided by the service provider device LAE in the request communication network AKN. By way of example, the communication terminal KEG can set up a call to a specific service call number, for example to a service call number starting with “0190” (not shown in the figure). Such a service is, by way of example, a “premium rate service” which involves transmitting information to service users. Alternatively, such a service can involve selling goods of any kind, supplying information, business services, entertainment services or, by way of example, games. In this exemplary embodiment, an information supply service will be provided by the request communication network AKN by way of example.

The communication terminal KEG has the associated credit account GK, which is intended to be used for billing for the service performed. This credit account contains a prepaid credit for the communication terminal KEG.

In the request communication network AKN, the service provider device LAE provides the information supply service. It instructs the payment request device ZAE to send a charging message VN. This charging message contains an identifier for the communication terminal KEG (for example an “SIP address” for the communication terminal KEG) and a payment sum, which is dependent on the chargeable service. The payment request device ZAE is in this case a switching center CSCF (CSCF=Call State Control Function). The charging message VN is thus addressed with the SIP address of the communication terminal KEG and is transferred to the signaling system SIP. The SIP address of the communication terminal KEG allows the signaling system SIP to route the charging message VN to the destination automatically (routing of messages, message routing mechanism). In the process, the charging message VN arrives (possibly via various switching centers (not shown)) at the appliance interface CSCF1 associated with the communication terminal KEG. The appliance switching center CSCF1 recognizes that this is a charging message VN. The appliance switching center stores information that such charging messages VN are not intended to be routed to the communication terminal KEG but rather to that account management device KFE which is associated with the credit account GK for the communication terminal KEG. The appliance switching center CSCF1 has a characteristic address for this account management device (it possibly reads this characteristic address from a data storage node in a communication network KN, or else the characteristic address may have been stored directly in the appliance switching center CSCF1). The appliance switching center then sends the charging message to the account management device KFE determined by this characteristic address. The account management device KFE now reads the identifier of the communication terminal KEG and the payment sum from the charging message VN. On the basis of the communication terminal's identifier, the account management device ascertains the credit account GK associated with the communication terminal. The account management device debits a debit sum which is dependent on the payment sum from the credit account. The debit sum can be the same as the payment sum, but it can also be determined from the payment sum by adding or subtracting charge sums.

When the debit sum has been debited from the credit account, the account management device instructs a unit in the communication network KN to return an acknowledgement message BN to the request communication network. This unit in the communication network KN can be the appliance switching center, the account management device KFE itself can send the acknowledgement message BN to the request communication network, or a further unit (not shown in the figure) can be instructed to send the acknowledgement message BN. The acknowledgement message BN is addressed with the SIP address of the payment request device ZAE, for example. Hence, the acknowledgement message BN is transmitted (routed) through the signaling system SIP from the communication network KN to the request communication network AKN, and hence the payment request device ZAE is informed about the successful debiting of the credit account.

However, it is likewise possible for the acknowledgement message BN to be addressed with the SIP address of the service provider device LAE (that is to say with a server's SIP address, for example). An acknowledgement message addressed in this manner is likewise routed to the payment request center ZAE by the signaling system, and said payment request center recognizes that this message is an acknowledgement message for the service provider device LAE and forwards the acknowledgement message BN to the service provider device LAE.

All method steps taking place are logged in the communication network KN, so that it is possible to check the billing at a later time and money can be transferred, by way of example, to a known bank account associated with the service provider conventionally on the basis of the debit sum debited from the credit account GK.

Charging messages can be used not just to transmit debit instructions to the account management device but also to reserve sums which are needed later in the credit account or to release reserved sums which are no longer needed. In this case, acknowledgement messages are returned to the request communication network on a similar basis to the method described previously.

The signaling system SIP can also be referred to as an “All-IP network” and is such a network.

A particular advantage of the inventive method is that no data need to be published from the communication network which describe the communication terminal KEG, users of the communication terminal, the credit account or the account management device KFE. In particular, it is not necessary to transmit the characteristic address of the account management address (sometimes also referred to as IP server address) to the request communication network AKN. This is of great advantage to the network operators of the communication network KN, since network operators often wish to avoid publishing characteristic addresses of account management devices or other network-internal data to other operators for reasons of security and competition. In addition, not publishing data makes it possible to prevent inferences relating to the internal network structure.

It is advantageously sufficient for the SIP address of the communication terminal KEG to be known in the request communication network for the purpose of sending said SIP address to the communication network KN with the charging message VN. Further user-specific data or data about the communication network KN are not necessary. In particular, the request communication network does not need to know the prepaid server address, because this address is known to the appliance switching center CSCF1 in the communication network KN.

Another advantage is that, for transmitting charging messages, it is possible to use all those security mechanisms which are used in the signaling system SIP (which is also referred to as SIP session control) for controlling setup, conducting and cleardown of communication links. These security mechanisms include, by way of example, authentication, authorization, integrity protection and protection of confidentiality. The security can be increased by encrypting or signing messages. All of these security mechanisms in the signaling system SIP can be used to transmit charging messages between various networks, that is to say e.g. between the communication network and the request communication network. This naturally also applies to acknowledgement messages or to other messages which need to be transmitted within the context of the billing method.

To transmit such messages, it is also possible to use message routing mechanisms in the signaling system; such mechanisms are also referred to as routing mechanisms of the SIP session control. In this context, charging messages between the networks are routed along the same path as messages for the session control. Charging messages can have a different entry or exit point, however. One possible exit point (termination point) in the prepaid server is the user's home network, and a possible entry point could be an application server (for example the service provider device LAE) in the service provider's network. The prepaid server can be found using the routing mechanisms, since it is in the path of the session control (of the signaling system SIP).

Another advantage of the inventive method for billing for services is that the service provider (the service provider device LAE) can be located in a different network than the credit account GK. The credit account GK is normally located in the home network of the communication terminal KEG. For a service provider, it is very advantageous for his service provider device LAE to have to be located just in a single network belonging to an individual operator, since other networks with connected communication terminals and credit accounts can also be reached from this network via the signaling system SIP for billing purposes. This saves the service provider time and money. Service users (like the communication terminal KEG) advantageously do not ever need to be logged into the service provider's network, nor does the service provider's network have to be the service user's home network. For the service user with the communication terminal KEG, it is advantageous that he can use the services of the service provider device LAE even though he remains anonymous and does not need to enter into a contractual agreement with the service provider. He also does not need to register with the service provider.

A particular advantage of the inventive method is that it is possible to bill for the services in real time. This means that it is possible to establish the ability of the user of the communication terminal KEG to pay before the service is actually used.

The network providing the service (request communication network) can communicate with the prepaid server in the user's home network before and during service use. In this case, it is possible to establish the user's ability to pay and to monitor this in real time during provision of the service. In the extreme case, if the user's credit has run out, the service can be terminated.

In addition, it is advantageously not necessary to forward user-specific information, such as the addresses of prepaid servers, to foreign networks (such as the request communication network AKN). The use of chargeable services can also be granted to such (prepaid) users as are not roaming in the service provider's network but instead are just selecting a service in this network (from another network).

Advantageously, a (prepaid) user can also use services which are not provided in his home network. In this context, the (prepaid) user can also be (be roaming) in another network.

Since the user's account management takes place in his home network but the service is provided in another network, the necessary charging information needs to be interchanged between the two networks. If, by way of example, the service provider's network requests that money be reserved, then the appropriate transactions are performed in the user's home network, and the service provider's network is then notified of whether there is sufficient coverage in the user account. The service provider's network can later assert payment requests up to the reserved level in the user's network.

In particular, it is possible, in principle, to use all SIP session control messages in order to interchange the charge messages between the networks KN and AKN. Examples of these SIP session control messages are INVITE, 200 OK, 183 Provisional Response, COMET, INFO. In the present example, the user calls up a service on the service provider device LAE (service or application server) in the foreign network AKN of the service provider. In line with the printed document 3GPP TS 23.228, the communication terminal KEG sends an SIP message “INVITE” which the service responds to with the SIP message “200 OK”. This SIP message “200 OK” contains a field into which it is possible to embed a charging message VN and a charging data item. In the present case, this can be a reservation request for a particular sum of money. The appliance switching center CSCF1 has a filter function and forwards those messages which contain charging information to the account management device KFE, which evaluates the part relating to the charging (and forwards the message to the actual receiver, the communication terminal KEG).

Alternatively, by way of example, the SIP message “200 OK” can also remain unchanged and additionally an SIP message “INFO” can be sent which is sent by the appliance switching center CSCF1 to the account management device KFE as the final receiver.

The account management device KFE reacts with an SIP message “INFO”, which likewise contains a field into which a charging message can be embedded and is sent to the foreign network AKN of the service provider. In the present case, this can be a reservation acknowledgement or rejection for the requested sum of money.

If charge requests now arise in the course of service use, these can be sent to the user's communication network KN by the service provider device LAE using the SIP message “INFO”. These messages, e.g. charge requests at a certain level, are filtered by the appliance switching center CSCF1 and are forwarded to the account management device KFE as final receiver. The account management device KFE reacts with an SIP message “INFO” into which a message relating to the charging is embedded and is sent to the network of the service provider. In the present case, this can be an acknowledgement or an error message.

When the user stops using the service, the service can release the remaining reservation. This message can also be embedded into an SIP message “INFO” and sent to the account management device KFE.

FIG. 2 shows the communication terminal KEG itself in the foreign network AKN, where it is logged on.

During setup of the SIP session, the network operator of the foreign network AKN sends a reservation request from his service provider device LAE to the network operator of the home network KN of the station KEG, which network operator controls the actual setup of the connection in the case of UMTS networks. Otherwise, the procedure takes place essentially as described above.

Naturally, the communication terminal KEG can alternatively also be located in a third network, which contains neither the account management device KFE nor the called service provider device (service server) LAE.

The way in which an SIP call or session is set up between two networks and controlled in the UMTS is described in the printed document 3G TS 23.228 V1.7.0. In this case, the service user's terminal interchanges SIP messages with the service provider's network via the signaling interface S shown in the illustration. If charging messages are now embedded into the session control, then advantageously no further interface and no new network elements are required for addressing and routing charging messages between the two network operators.

Another advantage of the proposed solution is that the addressing, routing and security infrastructure which is set up for the SIP session control in the UMTS can also be used for interchanging charging information between the networks. This reduces the costs, since no second infrastructure, with new network nodes e.g. specifically for routing charging messages, needs to be developed and set up.

Advantageously, the invention involves use of the mechanisms of the SIP session control in a UMTS network also for prepaid charging beyond network boundaries, or for prepaid charging within a network. Furthermore, the interchange of charging messages between network operators also allows provision of services for foreign subscribers who are not roaming in the network providing the service.

To reach a large number of potential service users, the services provided in a network are advantageously made available not just to the users domiciled in said network (home users) and to the users registered therein (roaming users), but also to the users of other telecommunication networks, such as those users whose home network is not identical to the service provider network and who are also not logged on there. Such network-independent provision of services increases the number of potential users and hence the provider's prospects for profit. The inventive method allows information to be interchanged between the networks, possibly in real time, so that those users who use a service in another network can also be charged. To this end, a method for transporting charging information between UMTS network operators or UMTS networks is described.

Another exemplary embodiment of the inventive method is illustrated below.

A user has a UMTS mobile telephone having a prepaid account with a German network operator and is situated in the latter's network. This user now wishes to view an interactive image sequence (video telephony call) which is provided by an American network operator. In this context, it does not matter whether this telephony service is provided by the network operator itself or else by a third party using the American operator's network. In addition to provision of the user service, it is necessary to charge for use of the service within the context of premium rate services, in which case the prepaid method needs to be used for this. While the SIP session is being set up, the American network operator sends a reservation request in this regard for 10 USD to the German network operator. This is done using the SIP session control's connection. The German network operator then reserves a corresponding sum in the user's prepaid account in the home network. When the user's acknowledgement has been picked up, the video telephony service is started. During the service, the American network operator sends a charging message for 50 cents to the prepaid server in Germany every 30 seconds, and this is debited from the service user's prepaid account. After three minutes, the user ends the call and the reservation for the remaining 7 USD is canceled.

A method for billing for services using a credit account has been described which can be used to carry out this billing beyond network boundaries or else within a network. The use of the signaling system SIP (for SIP session control) means that it is not necessary to develop and use an additional routing or security infrastructure, since the structures of the signaling system SIP can be used. The interchange of charging messages between network operators also allows services to be provided for foreign subscribers who are not roaming in the network providing the service.

1. A method for billing for chargeable services using a credit account (GK) which is managed in a communication network (KN) for a communication terminal (KEG) registered in the communication network (KN), in which
at least one charging message (VN) is transmitted from a payment request device (ZAE) to an account management device (KFE) for the credit account via a signaling system (SIP) in a communication network, which signaling system controls communication link setup, by virtue of
the charging message (VN) being provided with an address for the communication terminal (KEG) by the payment request device (ZAE),
the address of the communication terminal (KEG) being taken as a basis for routing the charging message (VN) from switching centers (ZAE) associated with the message routing mechanism to an appliance switching center (CSCF1) associated with the communication terminal (KEG),
the appliance switching center (CSCF1) taking the address of the communication terminal (KEG) as a basis for ascertaining a characteristic address for the account management device (KFE), and
the charging message (VN) being routed to the account management device (KFE) determined by this characteristic address.

2. The method as claimed in claim 1,
characterized in that
the charging message (VN) is routed to the account management device (KFE) by a packet-oriented message routing mechanism in the signaling system (SIP).

3. The method as claimed in one of the preceding claims,
characterized in that
the charging message (VN) is protected against access by unauthorized parties by a message protection mechanism in the signaling system (SIP).

4. The method as claimed in one of the preceding claims,
characterized in that
the charging message (VN) is used to transmit an identifier for the communication terminal (KEG) and a payment sum, and
the account management device (KFE) debits a debit sum, which is dependent on the payment sum, from the credit account (GK) when the charging message (VN) has arrived.

5. The method as claimed in claim 4,
characterized in that
debiting of the debit sum is followed by transmission of an acknowledgement message (BN) to the payment request device (ZAE).

6. The method as claimed in one of the preceding claims,
characterized in that
the communication network (KN) used is a communication network which has telecommunication links which are not protected against access by unauthorized parties.

7. The method as claimed in one of the preceding claims,
characterized in that
the payment request device (ZAE) used is a payment request device which is outside the control of an operator of the communication network (KN).

8. The method as claimed in one of the preceding claims,
characterized in that
the payment request device (ZAE) used is a payment request device which is associated with a request communication network (AKN) which is connected to the communication network (KN) by the signaling system (SIP).

9. The method as claimed in one of the preceding claims,
characterized in that
a signaling system (SIP) is used in which a message transmission protocol called the “Session Initiation Protocol” is used.
